(19) United States
(12) Patent Application Publication
(10) Pub. No.: US 2017/0279089 A1
(43) Pub. Date: Sep. 28, 2017

(54) LAMINATED CELL

(71) Applicant: TOYOTA JIDOSHA KABUSHIKI KAISHA, Toyota-shi (JP)

(72) Inventor: Hiroaki NISHINO, Susono-shi (JP)

(73) Assignee: TOYOTA JIDOSHA KABUSHIKI KAISHA, Toyota-shi (JP)

(21) Appl. No.: 15/450,533

(22) Filed: Mar. 6, 2017

(30) Foreign Application Priority Data
Mar. 22, 2016 (JP) 2016-057355

(51) Int. Cl. H01M 2/02; H01M 2/08

(52) U.S. Cl. CPC H01M 2/0287; H01M 2/08

(57) ABSTRACT

A laminated cell is provided having a cell element encapsulated in a laminate exterior body. The laminate exterior body has one or more flat laminate sheets, and two concave laminate sheets the outer perimeters of which rise from the bottom to form concave shapes. The two concave laminate sheets face each other across the cell element with the concave surfaces facing the exterior of the laminate exterior body, the pair of edges of the flat laminate sheets being joined to the entire outer perimeters of the concave laminate sheets, and the portion of the edges of the flat laminate sheets that are not joined to the entire outer perimeters of the edges of the concave laminate sheets are joined to each other, whereby the laminate exterior body forms a bag shape.

### RELATED APPLICATIONS

This application claims priority to Japanese Patent Application No. 2016-05735, filed Mar. 22, 2016, which is hereby incorporated by reference in its entirety.

### Technical Field

The present disclosure relates to a laminated cell having increased energy density.

### Background of the Invention

Laminated cells having a cell element housed in a laminate exterior body are known as thin and lightweight batteries. Laminated exterior bodies, having a multilayer structure with a sealant material layer on a thin metal layer of aluminum, stainless steel or the like, are lightweight and flexible and also resistant to acids and alkalis, and they are therefore suitable as materials for cell exterior bodies.

It is desirable to increase the energy density of laminated cells. One means that has been considered for increasing energy density is to reduce the volume at the sections that do not contribute to the cell reaction.

As described in Japanese Unexamined Patent Publication No. 2012-226826, a recess is formed at the section of the laminate exterior body housing the cell element to match the shape of the laminate exterior body to the shape of the cell element. This method is employed to reduce the volume of the laminate exterior body that occupies the total volume of the laminated cell, and increase the energy density of the laminated cell.

When a space that is to house a cell element has been formed into a laminate exterior body by embossing as described above, this creates excess space inside the laminate exterior body, that cannot house the cell element.

### SUMMARY OF THE INVENTION

It is therefore an object of the present disclosure to provide a laminated cell with increased energy density, by reducing the excess space inside the laminate exterior body that does not contribute to the cell reaction.

The means for solving the problems according to the disclosure are as follows.

Exemplary embodiments of the present invention provide a laminated cell having a cell element encapsulated in a laminate exterior body. The laminate exterior body has one or more flat laminate sheets and two concave laminate sheets the entire outer perimeters of which rise from the bottom to form concave shapes. The two concave laminate sheets face each other across the cell element with the concave surfaces facing the exterior of the laminate exterior body. The pair of edges of the flat laminate sheets are joined to the entire outer perimeters of the concave laminate sheets, and the edges among the edges of the flat laminate sheet(s) that are not joined to the entire outer perimeters of the edges of the concave laminate sheets are joined to each other, whereby the laminate exterior body is formed into a bag shape. Embodiments of the invention may also have a positive electrode collector tab and a negative electrode collector tab. The positive electrode collector tab and the negative electrode collector tab are electrically connected to the cell element, and run through from the interior to the exterior of the laminated cell at the sections where the edges of the flat laminate sheet(s) are joined together. The two concave laminate sheets may have the same shape and/or mirror symmetry, The bottoms of the concave laminate sheets may be polygonal. The bottoms of the concave laminate sheets may be hexagonal. The sections where the edges of the flat laminate sheet(s) are joined together are preferably in contact with the apices of the bottoms of the concave laminate sheets.

According to the embodiments described herein it is possible to provide a laminated cell with increased energy density, by reducing excess space inside the laminate exterior body that does not contribute to the cell reaction.

### BRIEF DESCRIPTION OF THE DRAWINGS

FIG. 1 is a schematic view of a laminated cell according to an embodiment of the disclosure;

FIG. 2 is a schematic view of the parts of a laminate exterior body of a laminated cell according to an embodiment of the disclosure;

FIG. 3 is a schematic view of the process of embossing of a laminate sheet;

FIG. 4 is a schematic view of a laminated cell according to an embodiment of the disclosure;

FIG. 5 is a schematic view of a laminated cell according to the prior art; and

FIG. 6 is a schematic cross-sectional view comparing the cross-sections of a laminated cell according to an embodiment of the disclosure and a laminated cell of the prior art.

Throughout the drawings, like reference numbers will be understood to refer to like features, elements, and structures.

### DETAILED DESCRIPTION OF EXEMPLARY EMBODIMENTS

Embodiments of the disclosure will now be described in detail in connection with the drawing, figures provided herewith. Those of ordinary skill in the art will recognize that the invention is not limited to the embodiments described herein, however, and various changes and modifications may be implemented within the scope of the invention as outlined in the claims.

A laminated cell according to an exemplary embodiment is a laminated cell having a cell element encapsulated in a laminate exterior body. The laminate exterior body has one or more flat laminate sheets, and two concave laminate sheets the entire outer perimeters of which rise from the bottom to form concave shapes. The two concave laminate sheets face each other across the cell element with the concave surfaces facing the exterior of the laminate exterior body. The pair of edges of the flat laminate sheets are joined to the entire outer perimeters of the concave laminate sheets, and the edges among the edges of the flat laminate sheets that are not joined to the entire outer perimeters of the edges of the concave laminate sheets are joined to each other, whereby the laminate exterior body is formed into a bag shape.

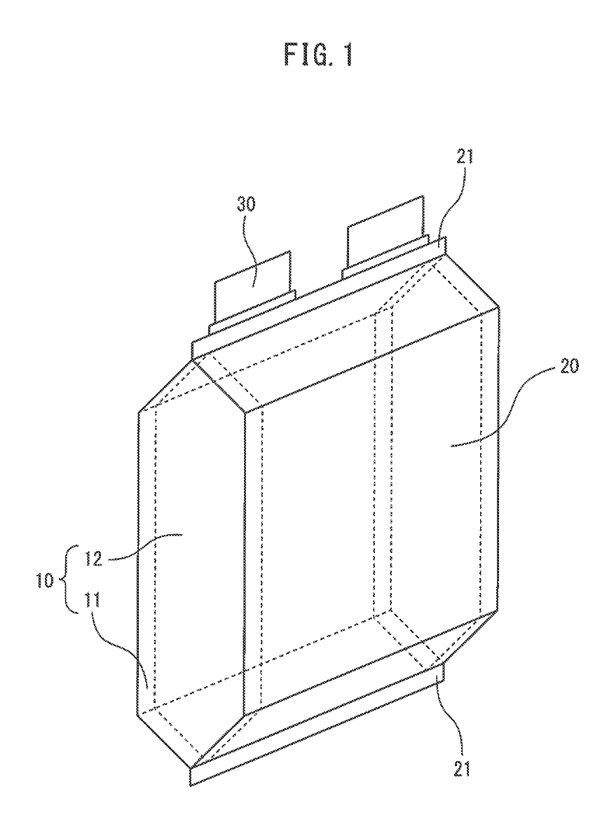

FIG. 1 is a schematic view of a laminated cell according to an exemplary embodiment of the disclosure. In FIG. 1, the two concave laminate sheets (10) form the opposite sides of the laminate exterior body, in such a manner that the concave surfaces are facing outwardly relative to the laminate exterior body. The pair of edges of the two flat laminate sheets (20) are joined with the entire outer perimeter (11) of the concave laminate sheets. The portion of the edges of the flat laminate sheets (20) that are not joined with the entire outer perimeter (11) of the concave laminate sheets are joined together, whereby the laminate exterior body forms a bag shape. In addition, a collector tab (30) runs through from the interior to the exterior of the laminated cell at the joined sections (21) of the edges of the flat laminate sheet.

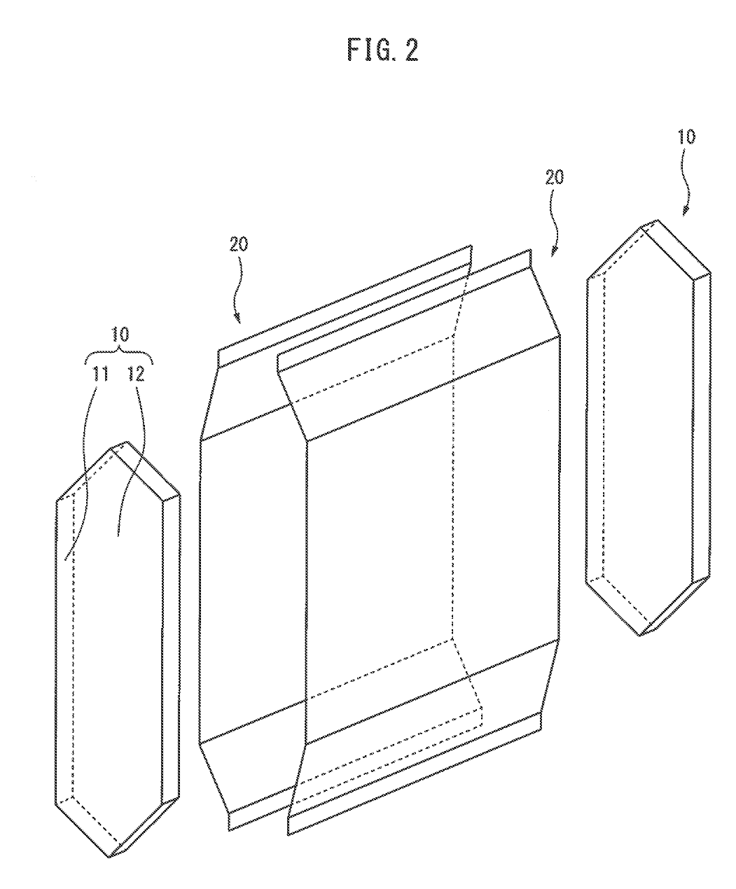

FIG. 2 is an exploded schematic view showing the parts composing a laminate exterior body according to an embodiment of the laminated cell of the disclosure. In FIG. 2, the parts composing the laminate exterior body are the two concave laminate sheets (10) and two flat laminate sheets (20). The two flat laminate sheets (20) are joined with the entire outer perimeter (11) of the concave laminate sheets. As also shown in FIG. 2, the entire outer perimeter (11) of the concave laminate sheets rise up from the bottoms (12) of the concave laminate sheets.

An exemplary process of embossing will now be described. However, it should be understood that the following description is intended to illustrate general principles and is merely exemplary, and the invention is not limited to the specific principles described below.

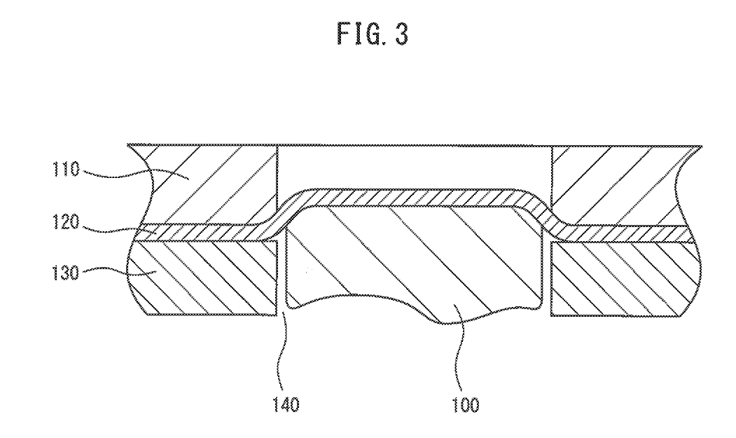

FIG. 3 is a schematic view of an exemplary process of embossing of a laminate sheet (120). In FIG. 3, the laminate sheet (120) is embossed using a die. The die is composed of a male die (100), a female die (110) and a crease presser plate (130). Gaps (140) are provided between the male die (100) and the female die (110).

When a recess is provided in the laminate sheet (120) by embossing as shown in FIG. 3, the corners formed by the embossing are rounded corners. Also, the recess to be formed is larger than the male die (100) by the distance of the gaps (140) between the male die (100) and the female die (110).

When embossing is carried out to form a conventional laminated cell as described above, and a space for housing the cell element is formed in the laminate exterior body, excess space is formed by the rounded corner sections and the sections of the gaps between the male die and the female die. The excess space narrows toward the sections where the laminate sheet is joined, and therefore it cannot be used to house the cell element. The energy density of the laminate exterior body is therefore reduced by the amount of the volume of the excess space. Stated differently, in regard to the size of the width of the laminate exterior body, the width of the laminate exterior body that can house the cell element is reduced by the degree necessary for embossing.

Consequently, in a laminated cell of the prior art in which embossing is carried out on a laminate exterior body to form a space to house a cell element, excess space is created inside the laminate exterior body along the perimeter where embossing occurs, and the energy density of the laminated cell is thereby reduced.

In contrast, in the laminated cell according to an exemplary embodiment of the present invention the laminate exterior body is made by joining two concave laminate sheets the entire outer perimeters of which rise from the bottom to form concave shapes, and flat laminate sheets, to adjust the laminate exterior body shape to the shape of the cell element.

Thus, the laminate exterior body of a laminated cell of the disclosure has the space that is to house the cell element formed by a different construction than a conventional laminated cell, and the interior space is not narrowed at the perimeter even at the sections that are joined with the laminate sheet.

This allows the laminated cell to house a larger cell element, and have increased energy density, compared to a conventional laminated cell having a laminate exterior body of the same size.

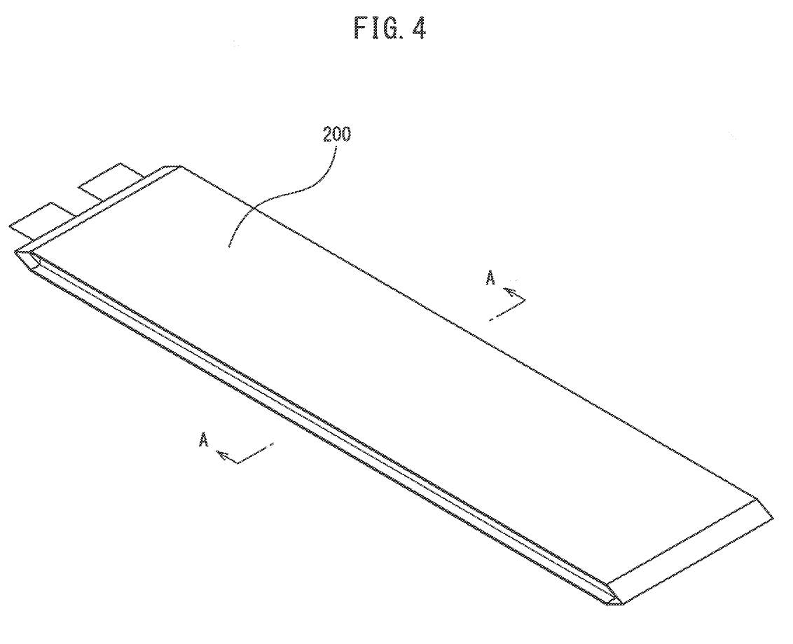

The differences between a conventional laminated cell and the laminated cell described herein will now be explained in further detail with reference to FIGS. 4 to 6.

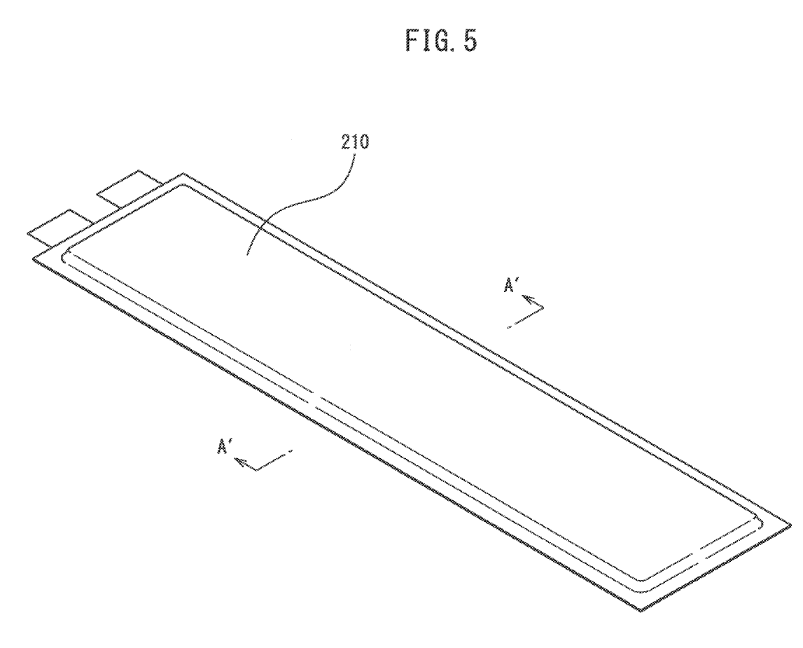

FIGS. 4 and 5 are schematic views of a laminated cell (200) based on an embodiment of the present disclosure, and a conventional laminated cell (210), respectively. (SEIWA—WE RECOMMEND ADDING THE LABEL “CONVENTIONAL” TO FIG. 5, AS THE USPTO MAY REQUIRE THIS LATER) It is intended that the laminated cells shown in FIGS. 4 and 5 have equal widths, that is, the magnitudes of lengths in the A-A direction. (FIG. 4) and in the A′-A′ (FIG. 5) direction.

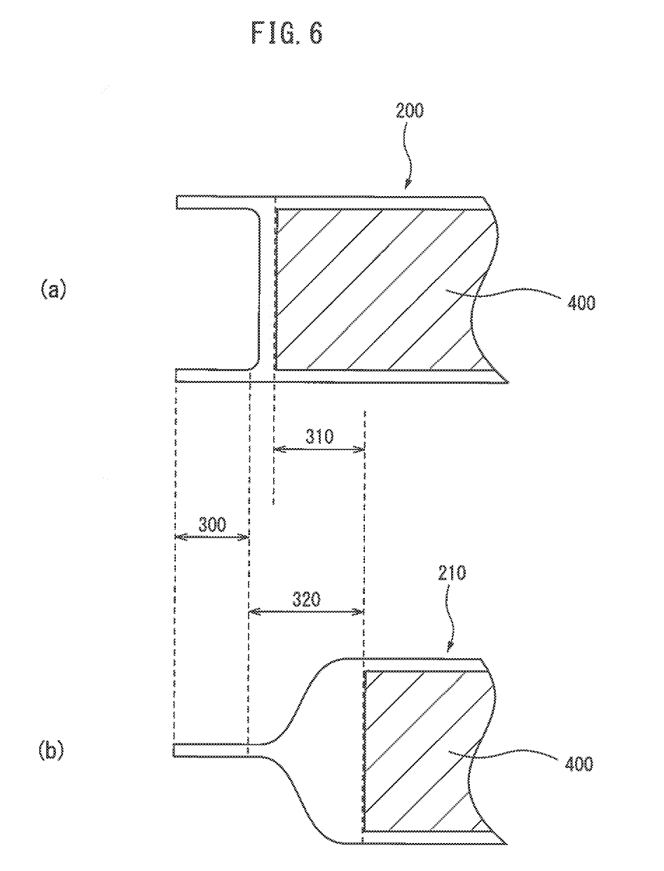

Also, FIG. 6(a) and (b) are, respectively, schematic views on cross-section A-A and cross-section A′-A′ of FIGS. 4 and 5.

FIGS. 6(a) and 6(b) show partial cross sections of the laminated cells illustrated in FIG. 4 and FIG. 5, respectively. In FIG. 6(a) and (b), the widths (300) of the sections where the laminate sheets are joined are all equal. In FIG. 6(b), however, the space that is to house a cell element inside the laminate exterior body is formed by embossing, and therefore sections are present in which the space that is to house the cell element (400) narrows, toward the sections where the laminate sheets are joined. As a result, a width (320) necessary for embossing, that is, excess space that cannot be used to house the cell element (400), is created in the widthwise direction of the conventional laminated cell. In FIG. 6(a), by contrast, the space that is to house the cell element (400) inside the laminate exterior body is such that advantageously no sections with reduced thickness are formed, so that it has extra space (310) in the width direction that can house the cell element (400), compared to a conventional laminated cell.

As used herein, the term “energy density” is to be understood to mean the volume energy density, which represents the energy of the cell per unit volume of the laminated cell.

The laminated cell described herein has a cell element encapsulated in a laminate exterior body. The laminated cell may also have a positive electrode collector tab and a negative electrode collector tab.

According to the disclosure, the laminate exterior body has one or more flat laminate sheets, and two concave laminate sheets.

A laminate sheet is preferably a sheet having a metal layer and a sealant material layer. The metal used for the laminate sheet may be aluminum or stainless steal, for example, and the sealant material layer may be a thermoplastic resin such as polypropylene, polyethylene, polystyrene, or polyvinyl chloride, for example.

The joined sections between the flat laminate sheets and concave laminate sheets and between the flat laminate sheets may be joined by any method so long as the method allows the sealing of the laminate exterior body interior to be maintained. Specific joining methods include without limitation any suitable methods of welding together the sealant material layers of laminate sheets. Alternatively, the laminate sheets may be bonded together with any suitable adhesive.

When the sealant material layers of the laminate sheets are to be welded together, this may be accomplished by any suitable method including without limitation hot plate welding, ultrasonic welding, vibration welding or laser welding.

The concave laminate sheets have their entire outer perimeters rising from the bottom portion to form concave shapes. The concave shape of each concave laminate sheet may be formed by embossing a single laminate sheet, or it may be formed by another method, such as cutting notches into the corner sections of the outer periphery of the laminate sheet and folding so that the outer periphery rises above the bottom, or any other suitable shaping method.

The bottoms of the concave laminate sheets are preferably flat in order to increase the space that is to house the call element of the laminate exterior body. Also, for easier joining of the flat sheets, the bottoms of the concave laminate sheets are preferably polygonal, and especially hexagonal or pentagonal. The two concave laminate sheets preferably have the same shape and/or mirror symmetry.

The laminate exterior body has one or more flat laminate sheets. The number of flat laminate sheet(s) is preferably 1 or 2.

In the case of a single fiat laminate sheet, the laminate exterior body can be formed in such a manner that the flat laminate sheet is wrapped around the entire outer perimeters of the two concave laminate sheets. If the laminate exterior body is formed in this manner, it is possible to reduce the sizes of the joined sections of the flat laminate sheet, allowing the energy density of the laminated cell to be further increased.

In the case of two flat laminate sheets, they are preferably placed so that the cell element is sandwiched by the two flat laminate sheets, the pair of edges of the two flat laminate sheets being joined to the concave laminate sheets while the remaining edges of the two flat laminate sheets are joined together, thereby forming the laminate exterior body, so that formation of the laminate exterior body is further facilitated.

The sections where the edges of the flat laminate sheets are joined together are preferably in contact with the apices of the bottoms of the concave laminate sheets. This is in order to create a more gentle angle at the border sections between the sections where the edges of the flat laminate sheets are joined together and the surrounding sections, compared to when the sections where the edges of the flat laminate sheets are joined together are not in contact with the non-apex sections of the bottoms of the concave laminate sheets, thereby increasing the strength at the sections where the edges of the flat laminate sheets are joined together.

The power generating element may be an all-solid-state battery comprising a positive electrode collector, positive electrode active material layer, solid electrolyte layer, negative electrode active material layer and negative electrode collector in that order, or a liquid battery in which a positive electrode collector, positive electrode active material layer, separator, negative electrode active material layer and negative electrode collector are impregnated with an electrolyte solution, However, it should be appreciated that these are merely exemplary, and embodiments of the invention may utilize any suitable power generating element.

Examples for the positive electrode collector and negative electrode collector include various metals, such as silver, copper, gold, aluminum, nickel, iron, stainless steel or titanium, or alloys thereof. When the power generating element is a lithium ion battery, the material of the positive electrode collector is preferably aluminum and the material of the negative electrode collector is preferably copper, from the viewpoint of chemical stability, The positive electrode collector and negative electrode collector are preferably composed of different materials.

The positive electrode active material layer, solid electrolyte layer and negative electrode active material layer are not particularly restricted so long as the power generating element has a construction exhibiting a function as a battery. For example, when the power generating element is a lithium ion battery, the positive electrode active material layer may have lithium cobaltate as the positive electrode active material, the solid electrolyte layer may have Li₂S-P₂S₅ as the sulfide solid electrolyte, and the negative electrode active material layer may have graphite as the negative electrode active material.

The positive electrode collector tab and negative electrode collector tab preferably are electrically connected to the cell element, and run through from the interior to the exterior of the laminated cell at the sections where the edges of the flat laminate sheet(s) are joined together. If the positive electrode collector tab and negative electrode collector tab are in such an arrangement, the sections where the edges of the flat laminate sheet(s) are joined together will also serve as sections joining the positive electrode collector tab and negative electrode collector tab to the laminated cell, thereby allowing the joining sections of the laminate exterior body to be reduced. By reducing the joining sections of the laminate exterior body it is possible to reduce the volume of the laminate exterior body and further increase the energy density.

Examples for the positive electrode collector tab and negative electrode collector tab include various metals, such as silver, copper, gold, aluminum, nickel, iron, stainless steel or titanium, as well as alloys thereof.

### EXPLANATION OF REFERENCE NUMBERS

10 Concave laminate sheet
11 Entire outer perimeter of concave laminate sheet
12 Bottom of concave laminate sheet
20 Flat laminate sheet
21 Section where edges of flat laminate sheets are joined together
30 Collector tab
100 Male die
110 Female die
120 Laminate sheet
130 Crease presser plate
140 Gap
200 Laminated cell according to embodiment of the disclosure
210 Prior art laminated cell
300 Width of section where laminate sheets are joined
310 Extra width allowing housing of cell element
320 Width necessary for embossing
400 Cell element

What is claimed is:

1. A laminated cell having a cell element encapsulated in a laminate exterior body, wherein
the laminate exterior body has one or more flat laminate sheets and two concave laminate sheets comprising a bottom and an outer perimeter, the entire outer perimeters of which rise from the bottom to form concave shapes,
the two concave laminate sheets face each other across the cell element with the concave surfaces facing the exterior of the laminate exterior body, the pair of edges of the flat laminate sheets being joined to substantially the entire outer perimeters of the concave laminate sheets, and the portions of the edges of the flat laminate sheet(s) that are not joined to the outer perimeters of the edges of the concave laminate sheets are joined to each other, whereby the laminate exterior body forms a bag shape.

2. A laminated cell according to claim 1, comprising a positive electrode collector tab, wherein
the positive electrode collector tab is electrically connected to the cell element, and run through from the interior to the exterior of the laminated cell at the sections where the edges of the flat laminate sheet(s) are joined together.

3. A laminated cell according to claim 2, further comprising a negative electrode collector tab, wherein the negative electrode collector tab is electrically connected to the cell element, and run through from the interior to the exterior of the laminated cell at the sections where the edges of the flat laminate sheet(s) are joined together.

4. A laminated cell according to claim 1, wherein the two concave laminate sheets have the same shape and/or mirror symmetry.

5. A laminated cell according to claim 1, wherein the bottoms of the concave laminate sheets are polygonal.

6. A laminated cell according to claim 5, wherein the bottoms of the concave laminate sheets are hexagonal.

7. A laminated cell according to claim 5, wherein the sections where the edges of the flat laminate sheet(s) are joined together are in contact with the apices of the bottoms of the concave laminate sheets.
